(19) United States
(12) Patent Application Publication
(10) Pub. No.: US 2005/0255889 A1
(43) Pub. Date: Nov. 17, 2005

(54) Mobile communication system, base station terminal, and control method therefor

(75) Inventors: Yukio Haseba, Tokyo (JP); Motoya Iwasaki, Tokyo (JP); Osami Nishimura, Tokyo (JP); Sei Hirade, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/102,672

(22) Filed: Apr. 11, 2005

(30) Foreign Application Priority Data
Apr. 30, 2004 (JP) 135206/2004

(51) Int. Cl. H04Q 7/20

(52) U.S. Cl. 455/561

(57) ABSTRACT

A control method comprises, transmitting wireless signals to an overall area assigned to said base station area; receiving wireless signals from the overall area; communicating via a first wireless channel with a terminal station located within the overall area; transmitting wireless signals to a limited area which lies within the overall area; receiving wireless signals from the limited area; and communicating via a second channel with the terminal station when the terminal station is located within the limited area.

This application is based upon and claims the benefit of priority from Japanese Patent Application No. 2004-135206, filed on Apr. 30, 2004, the content of which is incorporated herein by reference.

### BACKGROUND OF THE INVENTION

1. Technical Field

The present invention relates to mobile communication service technology and particularly to mobile communication service technology for providing radio communication service to a plurality of terminal stations existing within a cell formed by a base station.

2. Description of the Related Art

A conventional mobile communication service system of this type employs a cell structure which enables use of the same radio frequency within the cells not provided adjacently by dividing a service area into a plurality of communication areas called the cells and then allocating base stations to these cells for effective use of available radio frequencies. In a mobile communication service system of this type, the same radio frequency can be shared by a number of different cells.

Moreover, in order to achieve a shortened frequency repetition distance and to enhance effective use of the radio frequencies, one type of communication system further divides a cell into a plurality of sectors.

As an example of the mobile communication service system described above, Japanese Laid-Open Patent No. 047722/1992 (JP '722) discloses sectors formed with a directional antenna and provided within a cell. According to JP '722, a mobile terminal selects one channel resource from among all of the channel resources of the sectors of a cell to be used in accordance with amplitude of the received signals from the various sectors.

Moreover, Japanese Laid-Open Patent No. 055977/1997 (JP '977) discloses a communication system in which sectors are formed by a plurality of non-directional antennas. A different frequency is assigned to each of the plurality of non-directional antennas, and the sectors overlap within a single cell. According to this communication system, the channel resources which are shared by the sectors, are selectively assigned to the signals generated in the relevant sectors on the basis of a channel priority which has been previously set for each sector.

However, conventional mobile communication service systems as described above still have a problem that the communication systems cannot flexibly assign channel resources to a user as needed. Moreover, the communication systems described above cannot stably assign particular channel resources to particular users within particular areas provided in the cell without affecting or being affected by signal traffic in other areas within the cell.

For example, the system disclosed in JP '722 has the problem that because channel resources are selected by a mobile terminal station on the basis of the amplitude of reception signals at the position where the terminal station is located, the channel resources cannot be determined flexibly.

Moreover, the system disclosed in JP '977 has the problem that because channels shared by the sectors are assigned to the mobile terminal stations by a base station on the basis of a channel selection priority, it is impossible to assign particular channels to particular users within a particular area (e.g. within a particular sector) without affecting or being affected by signal traffic in other areas of the cell.

### BRIEF SUMMARY OF THE INVENTION

The present invention has been proposed to solve the problems described above and to provide an improved communication system. Therefore one object of the present invention is to provide a mobile communication service system and method which can flexibly assign channel resources to users. Another object of the present invention is to provide a mobile communication system which stably provides the channel resource to users in the a particular area provided within a wireless network, without affecting or being affected by signal traffic in the other areas within the wireless network area.

A control method according to one aspect of the present invention comprises, transmitting wireless signals to a broad geographic area assigned to said base station area (e.g. a general purpose cell); receiving wireless signals from the overall area; communicating via a first wireless channel with a terminal station located within the overall area; transmitting wireless signals to a limited area which lies within the overall area (e.g. an exclusive cell); receiving wireless signals from the limited area; and communicating via a second channel (e.g. a high communication channel), with the terminal station when the terminal station is located within the limited area.

A control method according to another aspect of the present invention comprises, transmitting and receiving first wireless signals to and from an overall area assigned to said base station (e.g. a general purpose cell); communicating via a wireless channel with a terminal station located within the overall area (e.g. an exclusive cell); transmitting and receiving second wireless signals to and from a limited area which lies within the overall area; and communicating via the wireless channel with the terminal station when the terminal station is located in the limited area, during only particular periods of time.

### BRIEF DESCRIPTION OF THE DRAWINGS

These and other features, aspects, and advantages of the present invention will become better understood with reference to the following description, amended claims, and accompanying drawings, which should not be read to limit the invention in any way, in which:

FIG. 1 illustrates a structure of a mobile communication service system of a first exemplary embodiment of the present invention.

FIG. 2 illustrates the structure of an exemplary base station according to the present invention.

FIG. 3 illustrates the structure of an exemplary terminal station according to the present invention.

FIG. 4 illustrates operations of a mobile communication service system of the first exemplary embodiment of the present invention.

FIG. 5 illustrates the structure of a mobile communication service system of a second exemplary embodiment of the present invention.

FIG. 6 illustrates the operations of a mobile communication service system of the second exemplary embodiment of the present invention.

FIG. 7 illustrates the structure of a mobile communication service system of a third exemplary embodiment of the present invention.

FIG. 8 illustrates the operations of a mobile communication service system of the third exemplary embodiment of the present invention.

FIG. 9 illustrates the operations of a mobile communication service system of a fourth exemplary embodiment of the present invention.

### DETAILED DESCRIPTION OF THE INVENTION

Exemplary embodiments of the invention are described below with reference to the attached figures. The described exemplary embodiments are intended to assist in the understanding of the invention and are not intended to limit the scope of the invention in any way.

### First Exemplary Embodiment

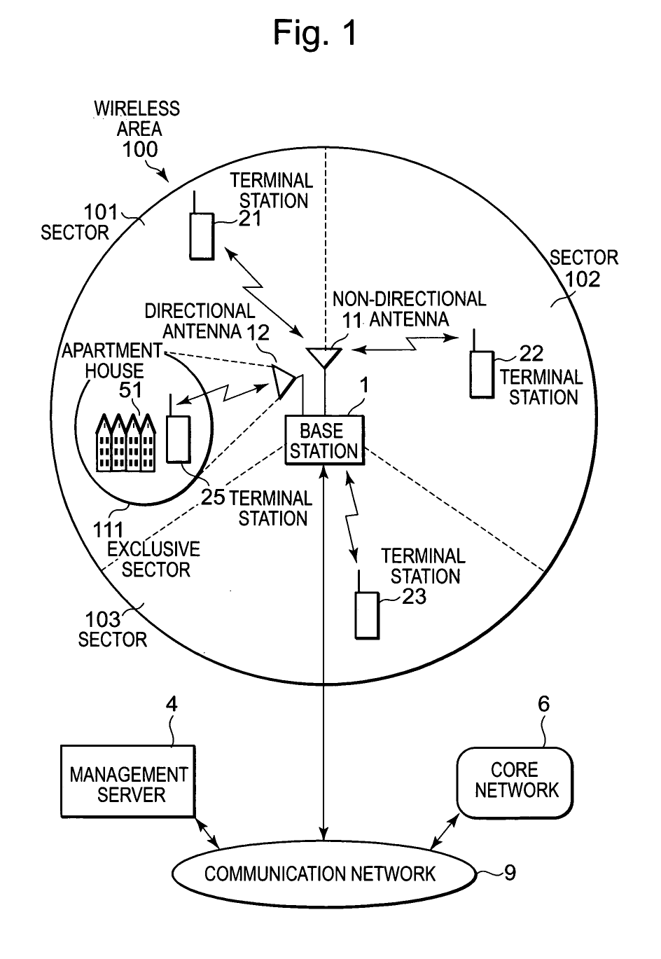

First, a mobile communication service system according to a first exemplary embodiment of the present invention will be described with reference to FIG. 1. FIG. 1 is a block diagram illustrating the structure of a mobile communication service system according to the first exemplary embodiment of the present invention.

This mobile communication service system comprises a base station 1, terminals 21, 22, 23, and 25, a management server 4, and a core network 6. The base station 1 and terminal stations 21, 22, 23, and 25 are connected via a radio link, while the base station 1, management server 4, and core network 6 are connected via a communication network 9.

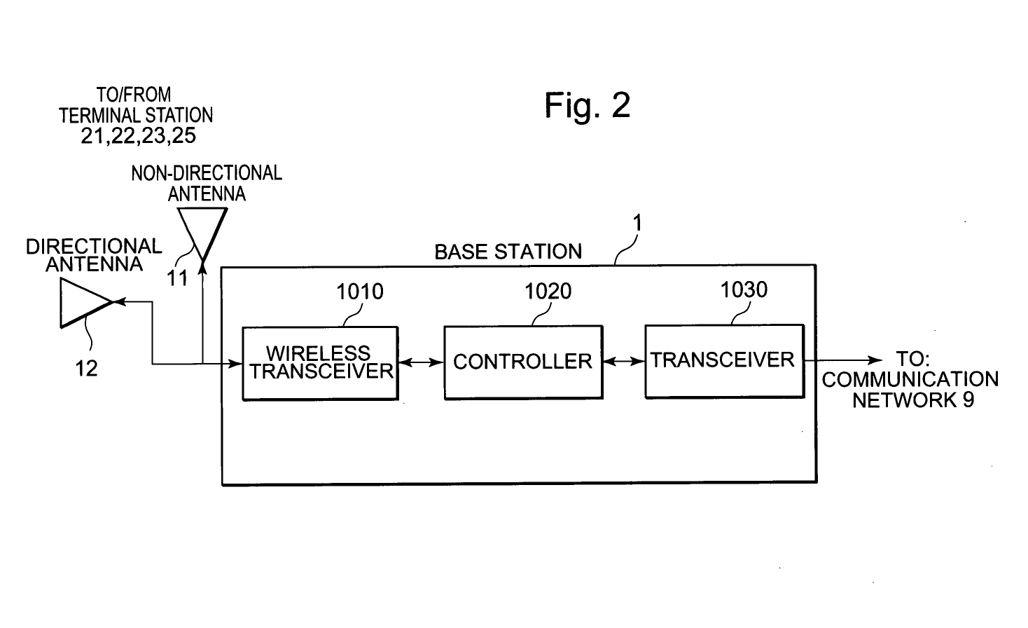

FIG. 2 shows a structure of the base station 1. The base station comprises a non-directional antenna 11, a directional antenna 12, a wireless transceiver 1010, a controller 1020, and a transceiver 1030. The wireless transceiver 1010 transmits and receives wireless signals to and from terminals 21, 22, 23, and 25 via the non-directional antenna 11 and the directional antenna 12. The transceiver 1030 transmits and receives signals to and from the communication network 9. The controller 1020 controls communications between the base station and the terminal stations and between the base station and the communication network 9. The controller 1020 transmits and receives signals to and from the terminal stations via the wireless transceiver 1010, the non-directional antenna 11, and the directional antenna 12. The controller 1020 also transmits and receives signals to and from the communication network 9 via the transceiver 1030.

Referring to FIG. 1, the base station 1 is connected to the terminal stations via a radio link providing mobile communication service. This base station 1 communicates with the terminal stations 21, 22, and 23 located in the sectors 101, 102, and 103, respectively, by means of a plurality of non-directional antennas 11. Sectors 101,102 and 103 are located within the broader wireless area 100 over which the base station can transmit and receive wireless signals. The base station 1 can also communicate with the terminal station 25, located within an exclusive sector 111 which is an individual area provided within the general purpose cell 100, by means of directional antennas 12.

The base station 1 transmits intrinsic cell information to all terminal stations within the wireless area 100 and to those terminal stations within the exclusive sector 111, via the non-directional antenna 11 and the directional antenna 12. Individual channel resources are provided to those terminal stations within both the wireless area 100 and the exclusive sector 111, and the antennas may use a common frequency or may use different frequencies for transmission and reception to the various sectors.

The terminal stations 21, 22, 23, and 25 may be mobile telephone terminal stations or mobile information terminal stations, or other terminal stations as would be understood by one of skill in the art.

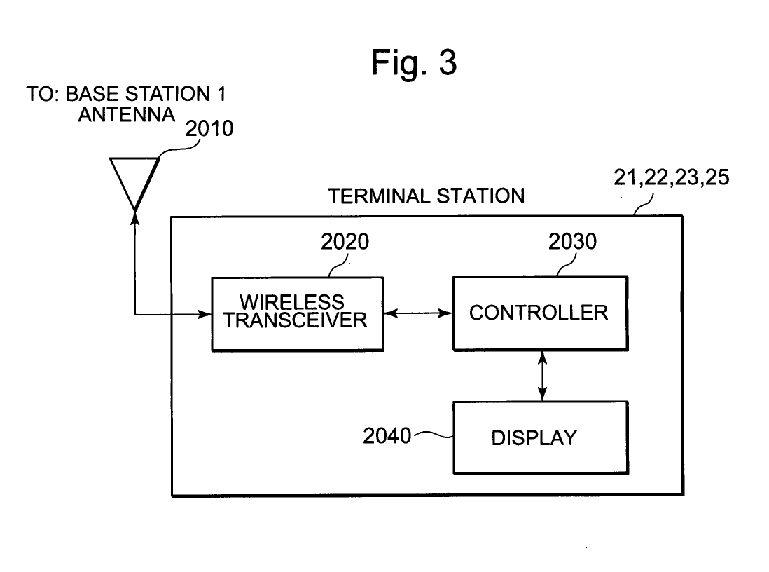

FIG. 3 shows an exemplary structure of a terminal station 21, 22, 23, or 25. The terminal station comprises an antenna 2010, a wireless transceiver 2020, a controller 2030, and a display 2040. The wireless transceiver 2020 transmits and receives wireless signals to and from the base station 1 via the antenna 2010. The display 2040 displays various information to a user. The controller 2030 controls communication between the terminal station and the base station 1, and controls the display 2040. The controller 2030 transmits and receives signals to and from the base station 1 via the wireless transceiver 2020 and the antenna 2010.

Referring to FIG. 1, the terminal stations may be radio terminal stations which issue connection requests to the base station 1. The communication requests include sector information, related to the sector in which the terminal station is located, which has been previously transmitted from the base station to the terminal stations within that sector. Once the requested connection is made, the terminal can then communication with a third party through the base station 1.

The management server 4 may be a computer or a CPU or any type of server as would be understood in the art, and may be used as a management apparatus for authenticating terminal station users on the basis of user information associated with the terminal station requesting the connection to the base station. Such user information is received by the base station from the terminal station and is then transmitted to the management server 4.

The core network 6 enables data communication between the terminal stations and third parties.

### Operations of the First Embodiment

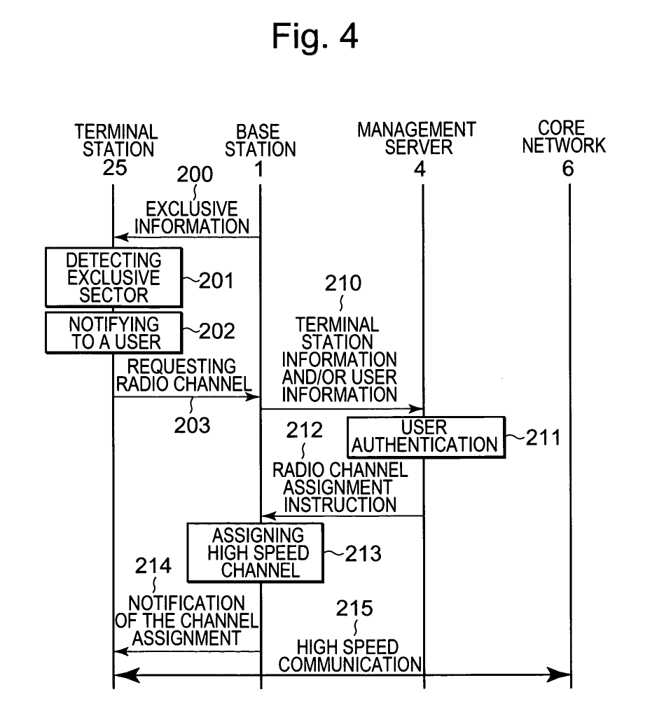

Next, exemplary operations of a mobile communication service system according to the first embodiment of the present invention will be described with reference to FIG. 4. FIG. 4 is a sequence diagram illustrating a mobile communication service system according to the first embodiment of the present invention.

According to one exemplary aspect of the first embodiment, an apartment house 51 is located within the geographic area defined by the exclusive sector 111, and a particular mobile communication service is provided for the terminal stations 25 of particular users living within the apartment house 51. This particular mobile communication service may be high speed communication with the core network 6, or may be another service as would be understood by one of skill in the art.

First, a terminal station 25 located within the exclusive sector 111, receives exclusive information, transmitted from the directional antenna 12 only to terminal stations within the exclusive sector 111, and also receives general purpose information, transmitted to all terminal stations within the wireless area 100, from the non-directional antenna 11 (step 200). Accordingly, within the exclusive sector 111, a connection request can be issued by the terminal 25 using either the exclusive information or the general purpose information.

Terminal station 25 detects the exclusive information corresponding to the exclusive sector 111, according to service information preset at the terminal station 25 (step 201).

Thus, when the exclusive information is detected by the terminal, this fact is notified to the user via the display 2040 (step 202). Accordingly, the particular users can recognize that the particular mobile communication service associated with the exclusive sector 111 can be used within the exclusive sector and can issue a request for the particular mobile communication service, through manipulation of the terminal station 25.

Responding to this manipulation, the terminal station 25 transmits a radio channel request, using the exclusive information to the base station 1 (step 203).

When the terminal station 25 is not located within the exclusive sector 111, the exclusive cell information cannot be received in step 200. Therefore, when the terminal station 25 is outside the exclusive sector, a connection request for the particular mobile communication service using the exclusive cell information cannot be issued.

When an arbitrary terminal station is located within the exclusive sector 111, it receives the exclusive cell information notified only to the exclusive sector 111, as does the terminal 25 (step 200). However, if the service information of the exclusive sector 111 is not yet registered at the arbitrary terminal station, the exclusive information cannot be detected in the step 201, and therefore, a connection request for the particular mobile communication service cannot be issued.

The base station 1 receives the radio channel assignment request from the terminal station 25 via the directional antenna 12 (step 203). Since this is a radio channel request for the particular mobile communication service provided within the exclusive sector 101, the base station transmits terminal station information, relating to the terminals station 25, and/or user information, relating to the user of terminal station 25, to the management server 4 (step 210).

The management server 4 executes authentication of the user information received from the base station 1, with reference to user management information registered previously in a database (step 211). When it is determined, based on the user information, that the user is permitted to use the particular mobile communication service provided within the exclusive sector 111, the management server 4 transmits a radio channel assignment instruction to the base station 1 (step 212).

If the user information of the terminal station is not registered in the database, the user cannot be identified as permitted to utilize the particular mobile communication service. Therefore, the management server 4 notifies the base station 1 that the radio channel assignment is invalidated, and the base station 1 does not assign the channel of the particular mobile communication service to the relevant terminal station.

According to the present example, in which the particular mobile communication service is high speed communication with the core network 6, the base station 1 assigns a high-speed down-stream channel, from the channel resources for the exclusive sector 111 to the terminal station 25 in accordance with the radio channel assignment instruction from the management server 4 (step 213), and notifies the terminal station 25 of the channel assignment (step 214).

The terminal station 25 starts high-speed data communication with a third party via the core network 6 using the assigned high-speed downstream channel in accordance with the notification from the base station 1 (step 215), and then completes the connection request process.

As described above, the base station transmits and receives to and from a broad wireless area by means of a non-directional antenna and transmits and receives to and from an exclusive sector, which is disposed within the broad wireless area, by means of a directional antenna. The base station transmits the exclusive information to users and executes authentication by transmitting the user information to the management server, in accordance with a connection request from the terminal station, using the exclusive cell information. In addition, the base station assigns a channel resource of the exclusive sector in accordance with a radio channel assignment instruction from the management server.

Accordingly, particular channel resources can be assigned stably to particular users in particular areas provided within a broader wireless area, without affecting or being affected by traffic in other sectors of the wireless area.

Moreover, the terminal station is capable of detecting exclusive information from the base station ton the basis of previously registered service information. However, a terminal station in which the service information is not registered cannot detect the exclusive information and also cannot issue a connection request for the particular mobile communication service provided within the exclusive sector. Accordingly, the particular service can be provided only to those particular terminal stations in which valid service information is registered.

Moreover, the terminal station notifies the user of the received exclusive information and also requests a radio channel in response to the operations by the user. Accordingly, a user within the exclusive sector can select whether the particular service provided within the exclusive sector will be utilized or whether the general service provided throughout the broader wireless area will be utilized.

Moreover, since the base station transmits user information to the management server so that the management server can execute authentication in accordance with the radio channel request, the radio channel is not assigned to a user or to a terminal station which is not previously registered at the management server. Therefore, the radio channel and the particular service may be provided for only those terminal stations and users for which valid user management information is registered.

Moreover, according to this embodiment, since the exclusive sector may be provided for fan apartment house, the residents of this apartment house may be registered as particular users, and the particular mobile communication service can be provided only for those residents.

Accordingly, an apartment house seller or an administrator of an apartment house can provide the particular additional value of the mobile communication service to the residents living in the apartment house. Moreover, it is possible for these persons to form business models for sales promotion of the apartment houses based on this available service.

### Second Exemplary Embodiment

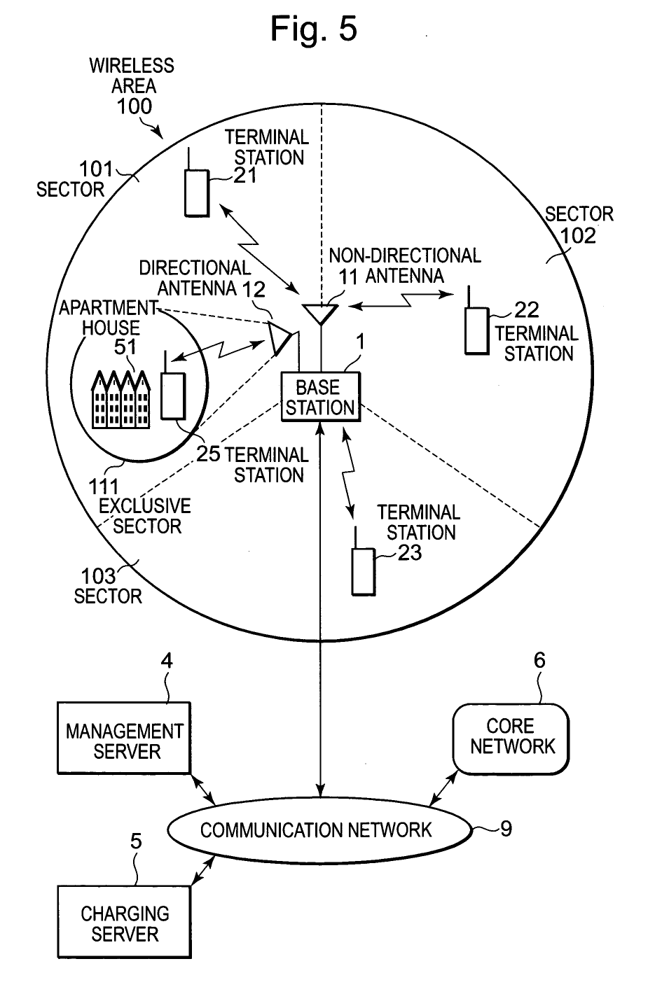

Next, an exemplary mobile communication service system according to a second embodiment of the present invention is described with reference to FIG. 5. FIG. 5 is a block diagram illustrating the structure of a mobile communication service system according to the second exemplary embodiment of the present invention. In FIG. 5, the elements like those of FIG. 1 are designated with the like reference numerals and the descriptions thereof are omitted here.

In this embodiment, a charging server 5, for charging users of the mobile communication service, is added to the system of the first embodiment described above. The charging sever 5 may be a computer which charges users in accordance with information transmitted by the management server 4 via a communication network 9. In an ordinary mobile communication service system, users are charged by a charging server for each use of the services, on the basis of various charging methods, such as a use-time charging method, a monthly charging method, or another method as would be understood by one of skill in the art.

According to the second embodiment, when particular mobile communication service, available only within an exclusive sector, is provided to a user, the communication system can flexibly determine whether the user is charged for the particular communication service, by means of the charging server 5.

### Operations of the Second Embodiment

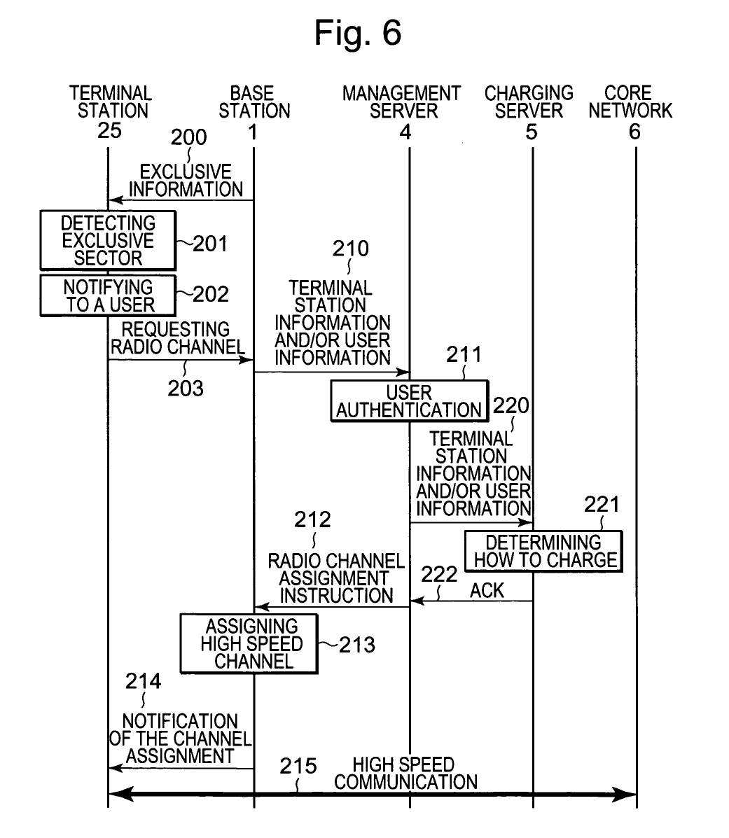

Next, operations of a mobile communication service system as the second embodiment of the present invention are described with reference to FIG. 6. FIG. 6 is a sequence diagram illustrating exemplary operations of a mobile communication service system of the second embodiment of the present invention.

Steps 200 to 211 in FIG. 6 are similar to steps 200 to 211 in FIG. 4. Thus, when a radio channel request is received from the terminal station 25, the base station 10 transmits the user information, included in the radio channel request, to the management server 4

The management server 4 executes the authentication of the user with reference to user management information registered previously in the database (step 211).

When it is determined that the user is permitted to use the particular mobile communication service provided within the exclusive sector 111, the management server 4 transmits a charging alteration request, including user information, to the charging server 5 (step 220).

The charging server 5 determines how to charge the user for the particular communication service, in accordance with the charging alteration request from the management server 4. According to the alteration request, the charging server 5 may determine to charge the user, not to charge the user, or to charge a third party, for the particular communication service (step 221). After this determination is made, the charging server 5 transmits an indication that the determination was made (ACK) (step 222).

The management server 4 then transmits a radio channel assignment instruction to the base station 1 in accordance with the indication from the charging server 5 (step 212). Subsequently, the steps 213 to 215, which are similar to steps 213 to 215 in FIG. 4, as described with respect to the first embodiment, are executed, and high-speed data communication between the terminal station and a third party can be executed via the core network 6 using a high-speed downstream channel.

As described above, the charging system can flexibly determine how to charge the user for the particular communication service, by means of the charging sever, in accordance with the notification from the management server 4. Accordingly, the particular mobile communication service can be provided to the user without charging the users or the service can be charged to a third party, thereby, providing a higher additional value for users and a business model enabling further promotion in the sales activity of an apartment house.

In addition, the mobile communication service provider is capable of charging a fee for user services to a third party, such as a seller or an administrator of an apartment house.

### Third Exemplary Embodiment

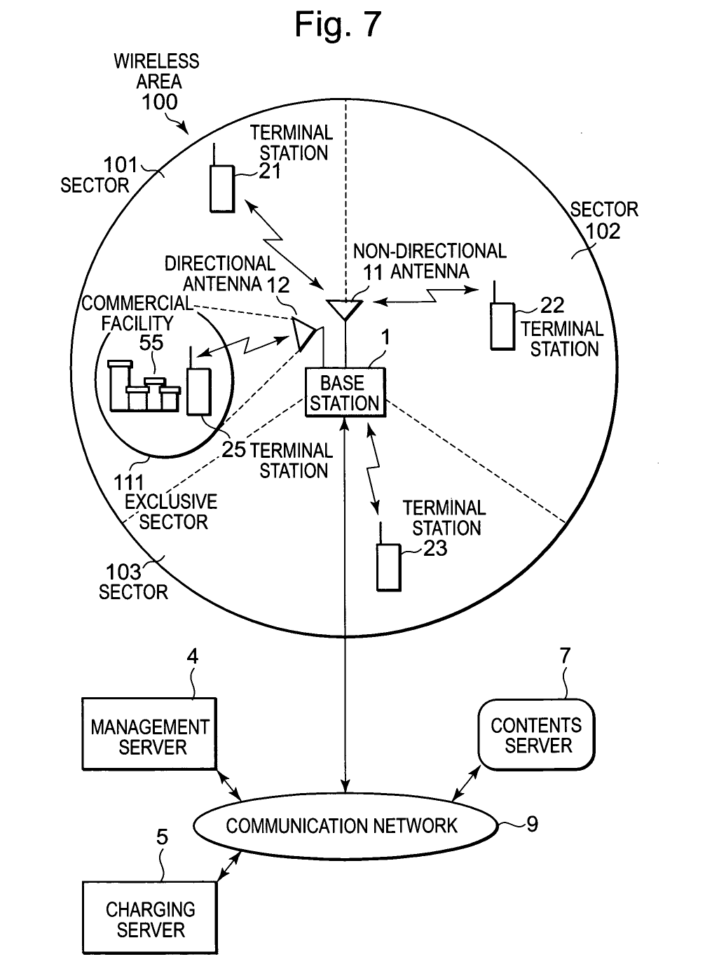

Next, an exemplary mobile communication service system according to a third embodiment of the present invention is described with reference to FIG. 7. FIG. 7 is a block diagram illustrating the structure of a mobile communication service system according to the third exemplary embodiment of the present invention. The elements in FIG. 7 like those of FIG. 5 are designated with like reference numerals and the descriptions thereof are omitted here.

In the examples of the embodiments described above, the particular mobile communication service is provided to particular users living in an apartment house within an exclusive sector. In this embodiment, the particular mobile communication service may be provided to users who have come to a commercial facility within an exclusive sector. With regard to the system structure, the core network 6 in FIG. 5 is replaced with a contents server 7 which distributes information corresponding or designated to the exclusive sector, to the terminal stations. The other elements in FIG. 7 are similar to those of the second embodiment (refer to FIG. 5).

### Operations of the Third Embodiment

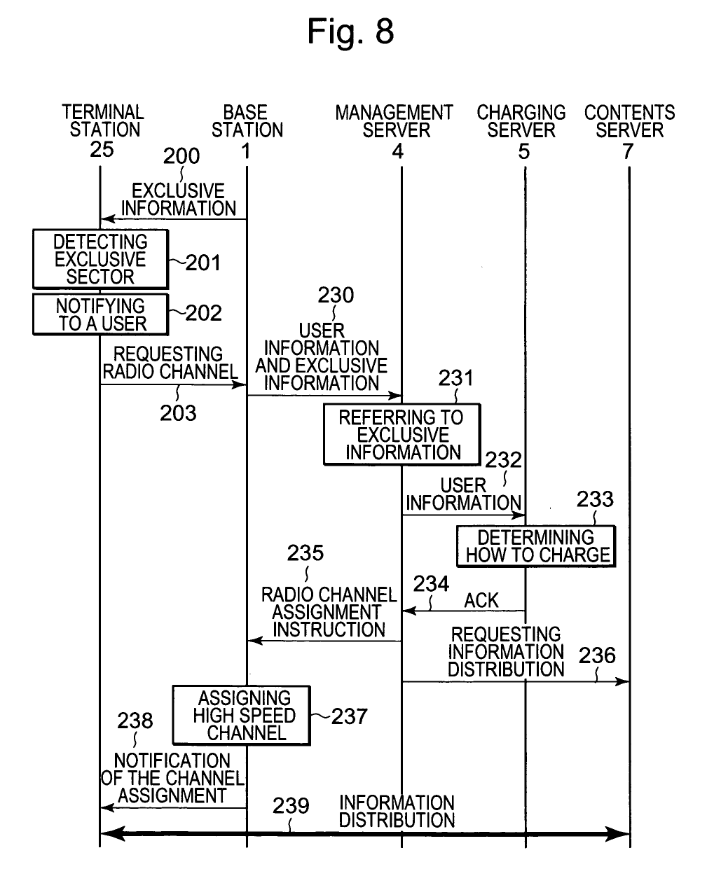

Next, exemplary operations of a mobile communication service system according to the third embodiment of the present invention are described with reference to FIG. 8. FIG. 8 is a sequence diagram illustrating operations of the mobile communication service system according to the third embodiment of the present invention.

The steps 200 to 203 of FIG. 8 are similar to those of FIG. 6. When a radio channel request is received from the terminal station 25, the base station 10 transmits the user information to the management server 4, in response to the radio channel request (step 230). In this case, the exclusive information corresponding to the exclusive sector is also transmitted to the management server 4.

The management server 4 refers to the exclusive information received from the base station 1 (step 231). The management server 4 transmits a charging alteration request, including the user information, to the charging server 5 (step 232),

The charging server 5 determines how to charge for the particular communication service, in accordance with the charging alteration request from the management server 4. The charging server 5 can determine to charge the user, not to charge the user, or to charge a third party, for the particular communication service (step 233). After this determination is made, the charging server 5 transmits an indication that the determination was made (ACK) (step 234).

The management server 4 transmits the radio channel assignment instruction to the base station 1, in accordance with the indication from the charging server 5 (step 235). The management server also transmits a request for distributing information corresponding or designated to the commercial facility, identified by the exclusive information, to the contents server 7 (step 236).

Subsequently, steps 237 to 239, which are similar to steps 213 to 214 in FIG. 6, as described with respect to the second embodiment, are executed, and then the contents server 7 transmits the information, corresponding or designated to the facility, to the terminal station 25 (step 239).

As described above, the channel resource designated for the exclusive sector is assigned to a terminal station in accordance with a radio channel request from the exclusive sector, and the information corresponding or designated to the relevant exclusive sector is distributed to the users. Accordingly, the information corresponding or designated to the relevant exclusive sector can be distributed smoothly to the users without affecting or being affected by the traffic in other sectors within the broader wireless area.

Therefore, an administrator of a commercial facility can provide the information about the commercial facility via the particular mobile communication service to users who have come to the commercial facility. Moreover, the administrator is capable of forming a business model aimed at an improvement in sales promotion a distribution of advertisements or guidance corresponding to the commercial facility.

### Fourth Exemplary Embodiment

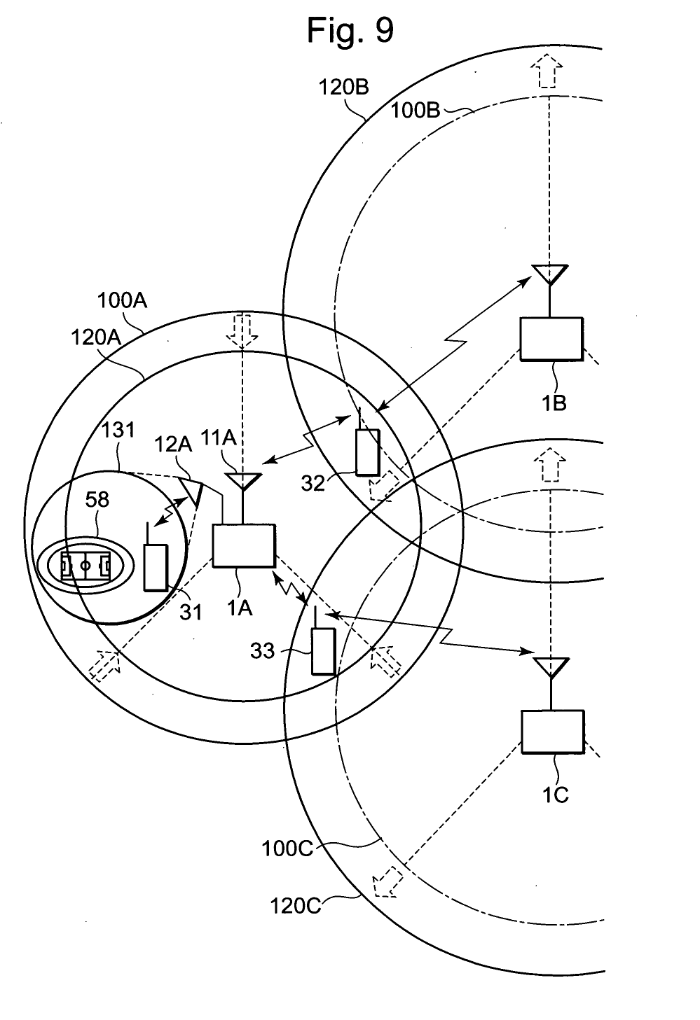

Next, an exemplary mobile communication service system according to a fourth exemplary embodiment of the present invention is described with reference to FIG. 9. FIG. 9 is a diagram for describing operations of a mobile communication service system according to the fourth embodiment of the present invention. With respect to channel assignment between the terminal station and the base station, to authentication, to charging, and to the distribution of information designated to the exclusive cell, the operation of this embodiment is similar to that of those embodiments described above. Therefore, detailed descriptions of the operation sequence is omitted here.

In each embodiment described above, the exclusive sector is provided via a directional antenna and channel resources of the base station are fixedly assigned to the exclusive sector. However, in this fourth embodiment, the exclusive sector may be utilized only during certain time periods, such that a channel resource can be typically used for the broader wireless area during all other times. Thereby, during the time when a channel resource is used for the exclusive sector, the range of the wireless area adjacent to the wireless area 100 may expand to compensate for the channel resource deviated from the wireless area 100.

Referring to FIG. 9, a communication system according to the fourth embodiment comprises base stations 1A, 1B, and 1C, and terminal stations 31 to 33. The base station 1A transmits and receives to and from a wireless area 100A via a non-directional antenna 11A, and may also transmit and receive to and from only an exclusive sector 131 via a directional antenna 12A. The base stations 1B and 1C transmit and receives to and from wireless area 100B and 100C, respectively, which are adjacent to the wireless area 100A.

When a game is held at a field 58, an exclusive sector 131 may be formed, encompassing the field 58, for the period of time during which the game is played. In this period of time, a portion of the channel resources dedicated to the wireless area 100A is reallocated for the exclusive sector. Therefore, in this period of time, the range of the wireless area 100A is reduced in size to 120A, according to the power redistribution at the base station 10A.

At this time, a management server, (not illustrated) gives instructions to the base stations 10B and 10C to expand the range of wireless areas 100B and 100C. In response to the instruction, the base stations 10B and 10C expand the wireless areas cells 100B and 100C to 120B and 120C, respectively, through power adjustment.

Accordingly, the terminal station 31 is capable of using the mobile communication service provided within the exclusive sector 131, while the terminal stations 32 and 33 are capable of using the mobile communication services provided within not only the wireless area 120A but also the wireless area 120B and 120C.

As described above, it is possible to form an exclusive sector for a particular area within a broader wireless area, for a particular period of time. During the particular period of time, a portion of the channel resources dedicated to the broader wireless area are reallocated to the exclusive sector. Moreover, the range of the broader wireless area is then reduced, and the range of adjacent wireless areas is expanded so that any shortage due to channel resources being reallocated to form the exclusive sector can be alleviated.

Moreover, in each embodiment described above, the directional antenna provided in the base station is used to transmit and receive to and from the exclusive sector. However, the directional antenna may be an extended antenna which is provided in an area near the particular area via an extension cable from the base station. In this case, an exclusive sector with an excellent radio wave condition can be formed even in an area where it would be difficult to form an exclusive sector with a directional antenna provided at the base station. When an extended antenna is used, a non-directional antenna may be used because the area where the extended antenna is arranged is near to the particular area. Accordingly, the directional antenna associated with the exclusive sector may be a directional antenna provided at the base station, but also may be a non-directional extended antenna, a directional extended antenna, or another means us would be understood by one of skill in the art.

While the present invention has been particularly illustrated and described with reference to exemplary embodiments thereof, the invention is not limited to these embodiments. It will be understood by those of ordinary skill in the art that various changes in structure, form, and details may be made thereto without departing from the spirit and scope of the present invention as defined by the following claims.

1. A mobile communication system, comprising:
a base station, comprising:
a first means for providing first wireless communication services within a first geographic area,
a second means for providing second wireless communication services within only a second geographic area, wherein the second geographic area is smaller than and located within the first geographic area; and
a mobile terminal, comprising:
a transmission and reception means for transmitting and receiving signals to and from the base station.

2. The mobile communication system, according to claim 1, wherein:
the base station further comprises:
control means for transmitting second area information to mobile terminals within only the second geographic area.

3. The mobile communication system, according to claim 2, wherein:
the mobile terminal further comprises:
notification means for notifying a user of second area information, in response to the reception of second area information by the transmission and reception means.

4. The mobile communication system according to claim 3, wherein:
the mobile terminal further comprises:
user input means for receiving user input, in response to the notification of the user of the second area information;
determination means for determining whether the user wishes to utilize the second wireless communication services based on received user input; and
connection request means for transmitting to the base station, via the transmission and reception means, a request for the second wireless communication services, in response to a determination, by the determination means, that the user wishes to utilize the second wireless communication services.

5. The mobile communication system according to claim 2, wherein:
the mobile terminal further comprises:
connection request means for transmitting to the base station, via the transmission and reception means, a request for the second wireless communication services, in response to the reception, by the transmission and reception means, of the second area information.

6. The mobile communication system according to claim 5,
wherein:
the request for a communication connection transmitted from the mobile terminal to the base station includes identification information identifying the mobile terminal or a user of the mobile terminal;
further comprising:
as authentication server, comprising:
authentication means for determining whether the mobile terminal is authenticated to utilize the second wireless communication services, based upon the identification information, and
transmission and reception means for transmitting channel assignment instructions to the base station upon a determination that the mobile terminal is authenticated; and
wherein the control means of the base station provides the second wireless communication services to the mobile terminal in response to a reception by the transmission and reception means of the base station of the channel assignment instruction.

7. The mobile communication system according to claim 6,
further comprising:
a charging server, comprising charging means for:
charging the user of the mobile terminal for the second wireless communication services provided to the mobile terminal, or
charging a third party for the second wireless communication services provided to the mobile terminal, or
determining that there is to be no charge for the second wireless communication services provided to the mobile terminal.

8. The mobile communication system according to claim 5, wherein the second wireless communication services are high-speed wireless communication services.

9. A mobile communication system, comprising:
a base station, comprising:
at least one first antenna which transmits and receives signals to and from a first geographic area;
at least one second antenna which transmits and receives signals to and from only a second geographic area, wherein the second geographic area is smaller than and located within the first geographic area; and
a mobile terminal, comprising:
at least one antenna which transmits and receives signals to and from the base station.

10. The mobile communication system according to claim 9, wherein:
the base station further comprises:
a controller which transmits second area information to mobile terminals within only the second geographic area via only the at least one second antenna.

11. The mobile communication system according to claim 10, wherein:
the controller of the base station provides second area wireless communication services only to mobile terminals within the second geographic area via the at least one second antenna; and
the mobile terminal further comprises:
a controller which transmits, via the at least one antenna, a request for the second area wireless communication services, in response to the reception, by the at least one antenna, of the second area information.

12. A mobile communication base station, comprising:
a first means for providing first wireless communication services within a first geographic area,
a second means for providing second wireless communication services within a second geographic area, wherein the second geographic area is smaller than and located within the first geographic area.

13. The mobile communication base station according to claim 12, further comprising:
control means for transmitting second area information to mobile terminals within only the second geographic area.

14. A mobile communication base station, comprising:
at least one first antenna which transmits and receives signals to and from a first geographic area; and
at least one second antenna which transmits and receives signals to and from only a second geographic area, wherein the second geographic area is smaller than and located within the first geographic area.

15. A mobile communication method, comprising:
at a base station:
providing first wireless communication services to mobile terminals within a first geographic area; and
providing second wireless communication services to mobile terminals within only a second geographic area, wherein the second geographic area is smaller than and located within the first geographic area.

16. The mobile communication method, according to claim 15, further comprising:
at the base station:
transmitting first area information to mobile terminals the first geographic area;
transmitting second area information to mobile terminals within only the second geographic area;
at a mobile station:
receiving the second area information from the base station;
notifying a user of the second area information;
transmitting a request for the second wireless communication services, including identification information identifying the mobile terminal or a user of the mobile terminal;
at an authentication server:
determining whether the mobile terminal is authenticated to utilize the second wireless communication services based on the identification information;
if the mobile terminal is authenticated to utilize the second wireless communication services, transmitting a channel assignment instruction to the base station;
at the base station:
providing the second wireless communication services to the mobile station in response to the channel assignment instructions.

17. The mobile communication method, according to claim 16, further comprising:
at a charging server:
charging the user of the mobile terminal or a third party for the second wireless communication services provided to the mobile terminal or determining that there is no charge for the second wireless communication services provided to the mobile terminal.

18. The mobile communication method according to claim 16, wherein the second wireless communication services are high-speed wireless communication services.

19. A mobile communication system, comprising:
a first base station, comprising:
a first means for, during a first time period, providing first wireless communication services within a first geographic area; and
a second means for,
during only a second time period, providing second wireless communication services within only a second geographic area, wherein the second geographic area is smaller than and located within the first geographic area,
wherein the second time period is less than the first time period; and
at least one second base station, comprising:
means for providing first wireless communication services within a third geographic area, wherein the third geographic area is adjacent to the first geographic area; and
means for enlarging the third geographic area during the second time period;
a mobile terminal, comprising:
a transmission and reception means for transmitting and receiving signals to and from the first base station and the at least one second base station.

20. The mobile communication system, according to claim 19, wherein:
the first base station further comprises:
control means for transmitting second area information to mobile terminals within only the second geographic area, only within the second time period.

21. The mobile communication system, according to claim 20, wherein:
the mobile terminal further comprises:
notification means for notifying a user of second area information, in response to the reception of second area information to the transmission and reception means.

22. The mobile communication system, according to claim 21, wherein:
the mobile terminal further comprises:
user input means for receiving user input, in response to the notification of the user of the second area information;
determination means for determining whether the user wishes to utilize second wireless communication services based on received user input; and
connection request means for transmitting to the first base station, via the transmission and reception means, a request for the second wireless communication services, in response to a determination by the determination means, that the user wishes to utilize the second wireless communication services.

23. The mobile communication system, according to claim 20, wherein:
the mobile terminal further comprises:
connection request means for transmitting to the first base station, via the transmission and reception means, a request for the second wireless communication services, in response to the reception, by the transmission and reception means, of the second area information.

24. The mobile communication system, according to claim 23,
wherein:
the request for a communication connection transmitted form the mobile terminal to the first base station includes identification information identifying the mobile terminal or a user of the mobile terminal;
further comprising an authentication server, comprising:
authentication means for determining whether the mobile terminal is authenticated to utilize the second wireless communication services, based upon the identification information, and
transmission and reception means for transmission channel assignment instructions to the first base station upon a determination that the mobile terminal is authenticated; and
wherein the control means of the first base station provides the second wireless communication services to the mobile terminal in response to a reception by the transmission and reception means of the first base station of the channel assignment instruction.

25. The mobile communication system, according to claim 24, further comprising:
a charging server, comprising charging means for:
charging the user of the mobile terminal for the second wireless communication services provided to the mobile terminal, or
charging a third party for the second wireless communication services provided to the mobile terminal, or
determining that there is to be no charge for the second wireless communication services provided to the mobile terminal.

26. A mobile communication system, comprising:
a first base station, comprising:
at least one first antenna which, during a first time period, transmits and receives signals to and from a first geographic area;
at least one second antenna which,
during only a second time period transmits and receives signals to and from only a second geographic area, wherein the second geographic area is smaller than and located within the first geographic area;
wherein the second time period is less than the first time period; and
at least one second base station, comprising:
at least one antenna which transmits and receives signals to and from a third geographic area, wherein the third geographic area is adjacent to the first geographic area; and
a controller which enlarges the third geographic area during the second time period; and
a mobile terminal, comprising:
at least one antenna which transmits and receives signals to and from the first base station and the at least one second base station.

27. The mobile communication system, according to claim 26, wherein:
the first base station further comprises:
a controller which transmits second area information to mobile terminals within only the second geographic area, only within the second time period, via only the at least one second antenna.

28. The mobile communication system, according to claim 27, wherein:
the controller of the first base station provides second area wireless communication services only to mobile terminals within the geographic area, only within the second time period, via the at least one second antenna; and
the mobile terminal further comprises:
a controller which transmits, via the at least one antenna, a request for the second area wireless communication services, in response to the reception, by the at least one antenna, of the second area information.

29. A mobile communication base station, comprising:
a first means for, during a first time period, providing first wireless communication services within a first geographic area; and
a second means for,
during only a second time period, providing second wireless communication services within only a second geographic area, wherein the second geographic area is smaller than and located within the first geographic area,
wherein the second time period is less than the first time period.

30. The mobile communication base station, according to claim 29, further comprising:
control means for transmitting second area information to mobile terminals within only the second geographic area, only within the second time period.

31. A mobile communication base station, comprising:
at least one first antenna which, during a first time period, transmits and receives signals to and from a first geographic area; and
at least one second antenna which,
during only a second time period transmits and receives signals to and from only a second geographic area, wherein the second geographic area is smaller than and located within the first geographic area;
wherein the second time period is less than the first time period.

32. A mobile communication method, comprising:
at a first base station:
during a first time period, providing first wireless communication services to mobile terminals within a first geographic area; and
during only a second period of time, providing second wireless communication services to mobile terminals within only a second geographic area, wherein the second geographic area is smaller than and located within the first geographic area and wherein the second time period is less than the first time period; and
at at least one second base station:
providing first wireless communication services to mobile terminals within a third geographic area, wherein the third geographic area is adjacent to the first geographic area; and
enlarging the third geographic area during the second time period.

33. The mobile communication method, according to claim 32, further comprising:
at the first base station:
transmitting first area information to mobile terminals within the first geographic area;
transmitting second area information to mobile terminals within only the second geographic area, only during the second time period;
at a mobile station:
receiving the second area information from the base station;
notifying a user of the second area information;
transmitting a request for the second wireless communication services, including identification information identifying the mobile terminal or a user of the mobile terminal;
at an authentication server:
determining whether the mobile terminal is authenticated to utilize the second wireless communication services based on the identification information;
if the mobile terminal is authenticated to utilize the second wireless communication services, transmitting a channel assignment instruction to the first base station;
at the first base station:
providing the second wireless communication services to the mobile station in response to the channel assignment instructions.

34. The mobile communication method, according to claim 33, further comprising:
at a charging server:
charging the user of the mobile terminal or a third party for the second wireless communication services provided to the mobile terminal or determining that there is no charge for the second wireless communication services provided to the mobile terminal.
